(19) United States
(12) Patent Application Publication
(10) Pub. No.: US 2012/0113157 A1
(43) Pub. Date: May 10, 2012

(54) LIQUID CRYSTAL DISPLAY DEVICE AND DRIVING METHOD OF THE SAME

(76) Inventors: Gee-Bum KIM, Yongin-City (KR); Won-Sang Park, Yongin-city (KR); Jae-Hyun Kim, Yongin-city (KR); Jae-Ik Lim, Yongin-city (KR); Jong-In Baek, Yongin-city (KR); Yong-Seok Yeo, Yongin-city (KR)

(21) Appl. No.: 13/186,870

(22) Filed: Jul. 20, 2011

(30) Foreign Application Priority Data
Nov. 8, 2010 (KR) 10-2010-0110574

(51) Int. Cl. G09G 3/36; G09G 5/02

(52) U.S. Cl. 345/690; 345/88

(57) ABSTRACT

Embodiments relate to a liquid crystal display (LCD) and a driving method thereof, a driving method of a liquid crystal display (LCD) including a liquid crystal layer having a hysteresis characteristic according to a plurality of voltage curves for a liquid crystal applying voltage versus transmittance includes: applying a reset voltage to the liquid crystal layer before a plurality of gray voltages according to grayscale data of one frame; generating the gray voltages corresponding to one voltage curve selected according to the applied reset voltage among a plurality of curves according to the hysteresis characteristic; and applying the gray voltages to a corresponding region of the liquid crystal layer.

### CROSS-REFERENCE TO RELATED APPLICATIONS

This application claims priority to and the benefit of Korean Patent Application No. 10-2010-011574 filed in the Korean Intellectual Property Office on Nov. 8, 2010, the entire contents of which are incorporated herein by reference.

### BACKGROUND

1. Field

Embodiments relate to a liquid crystal display (LCD) and a driving method.

More particularly, embodiments relate to a driving method expressing a grayscale with a desired luminance without an influence of a previous grayscale in a driving method of a liquid crystal display (LCD) including a liquid crystal layer having a hysteresis characteristic.

2. Description of the Related Art

Recently, various flat panel displays capable of reducing weight and volume have been developed. Weight and volume are disadvantages of a cathode ray tube. Among flat panel displays are a liquid crystal display (LCD), a field emission display (FED), a plasma display panel (PDP), an organic light emitting diode (OLED) display, etc.

### SUMMARY

Embodiments may be directed to a liquid crystal display, and a driving method thereof. Embodiments may also be directed to a method of displaying with a gray voltage.

A driving method of a liquid crystal display (LCD) according to an exemplary embodiment includes a liquid crystal layer having a hysteresis characteristic according to a plurality of voltage curves for a liquid crystal applying voltage versus transmittance.

The driving method of the liquid crystal display (LCD) according to an exemplary embodiment includes: applying a reset voltage to the liquid crystal layer before a plurality of gray voltages according to grayscale data of one frame; generating the gray voltages corresponding to one voltage curve selected according to the reset voltage among the plurality of curves according to the hysteresis characteristic; and applying the gray voltages to a corresponding region of the liquid crystal layer.

The reset voltage may be a saturation voltage or a threshold voltage.

The one voltage curve selected according to the reset voltage may be a voltage curve according to a direction that the liquid crystal applying voltage is decreased from a maximum value to a minimum value among the plurality of voltage curves when the reset voltage is the saturation voltage.

The voltage curve selected according to the reset voltage may be a voltage curve according to a direction that the liquid crystal applying voltage is increased from a minimum value to a maximum value among the plurality of voltage curves when the reset voltage is the threshold voltage.

The saturation voltage of the voltage curve may be a white voltage in a case of a normally black mode, and may be a black voltage in a normally white mode.

The liquid crystal layer may be a polymer dispersed liquid crystal layer in which a liquid crystal, a reactive mesogen (RM), and a polymer compound are mixed.

The polymer dispersed liquid crystal layer may include one selected from a polymer dispersed liquid crystal (PDLC), a polymer network liquid crystal (PNLC), a polymer stabilized liquid crystal (PSLC), a liquid crystal stabilized polymer (LCSP), and a polymer stabilized ferroelectric liquid crystal (PSFLC).

A driving method of a liquid crystal display (LCD) including a liquid crystal layer having a hysteresis characteristic according to a plurality of voltage curves for a liquid crystal applying voltage versus transmittance and displaying a predetermined color by sequentially driving the liquid crystal layer during one frame period that is divided into a plurality of sub-frames includes: applying a reset voltage to the liquid crystal layer before a plurality of gray voltages according to grayscale data of every sub-frame of the plurality of sub-frames; generating the gray voltages corresponding to one voltage curve selected according to the reset voltage among the plurality of curves according to the hysteresis characteristic; and applying the gray voltages to a corresponding region of the liquid crystal layer.

The one voltage curve may be a voltage curve according to a direction that the liquid crystal applying voltage is decreased from a maximum value to a minimum value among the plurality of voltage curves.

The plurality of sub-frames may include Red (R), Green (G), and Blue (B) sub-frames.

The plurality of sub-frames may respectively include a first section in which the reset voltage is applied to the liquid crystal layer and a second section in which the gray voltages corresponding to one voltage curve selected among the plurality of voltage curves are applied to the corresponding region of the liquid crystal layer.

A liquid crystal display (LCD) includes: a plurality of pixels including a liquid crystal layer having a hysteresis characteristic of a plurality of voltage curves of a liquid crystal applying voltage versus transmittance and displaying an image; a plurality of scan lines simultaneously transmitting a scan signal of a gate on voltage level to the plurality of pixels during a predetermined first period of one frame period and sequentially transmitting the scan signal of the gate on voltage level to the plurality of pixels during a predetermined second period of one frame period; a plurality of data lines transmitting a reset voltage to the plurality of pixels during the predetermined first period and transmitting a plurality of gray voltages generated corresponding to one voltage curve selected according to the reset voltage among the plurality of voltage curves according to the hysteresis characteristic during the predetermined second period; and a plurality of common electrode lines supplying a common voltage to the plurality of pixels, wherein the plurality of pixels display a grayscale by applying the gray voltages transmitted during the predetermined second period to a corresponding region of the liquid crystal layer.

The one voltage curve may be a voltage curve according to a direction that the liquid crystal applying voltage is decreased from a maximum value to a minimum value among the plurality of voltage curves.

The reset voltage may be a saturation voltage or a threshold voltage

The plurality of pixels may respectively include: a thin film transistor including a gate electrode connected to a corresponding scan line of the plurality of scan lines, a first electrode connected to a corresponding data line of the plurality of data lines, and a second electrode connected to a pixel electrode and turned on according to the scan signal transmitted through the corresponding scan line of the plurality of scan lines to receive the reset voltage and the plurality of gray voltages through the data line; a storage capacitor connected to the second electrode of the thin film transistor and maintaining a pixel voltage applied to the pixel electrode; and a liquid crystal layer interposed between the pixel electrode connected to the second electrode of the thin film transistor and the common electrode.

### BRIEF DESCRIPTION OF THE DRAWINGS

The above and other features will become more apparent to those of ordinary skill in the art by describing in detail exemplary embodiments with reference to the attached drawings, in which:

FIG. 1 illustrates a circuit diagram of a pixel driving circuit according to an exemplary embodiment.

FIG. 2 illustrates a timing diagram explaining an operation of a pixel driving circuit of FIG. 1 according to an exemplary embodiment.

FIG. 3 illustrates a timing diagram explaining an operation of a pixel driving circuit of FIG. 1 according to another exemplary embodiment.

FIG. 4 and FIG. 5 illustrate V-T curve graphs to explain a driving method of a liquid crystal display (LCD) according to an exemplary embodiment.

FIG. 6 illustrates a V-T curve graph showing a state in which an expression of grayscales is improved according to a driving method of a liquid crystal display (LCD) according to an exemplary embodiment.

FIG. 7 illustrates a graph showing a V-T curve of a liquid crystal display (LCD).

FIG. 8 illustrates a graph showing a V-T curve for a color of a liquid crystal display (LCD) having a liquid crystal layer of a hysteresis characteristic.

### DETAILED DESCRIPTION

Example embodiments will now be described more fully hereinafter with reference to the accompanying drawings; however, they may be embodied in different forms and should not be construed as limited to the embodiments set forth herein.

Hereinafter, present embodiments will be described more fully with reference to the accompanying drawings, in which exemplary embodiments are shown. As those skilled in the art would realize, the described exemplary embodiments may be modified in various different ways, all without departing from the spirit or scope of present embodiments.

Further, like reference numerals denotes like components throughout several exemplary embodiments. A first exemplary embodiment will be representatively described, and therefore only components other than those of the first exemplary embodiment will be described in other exemplary embodiments.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

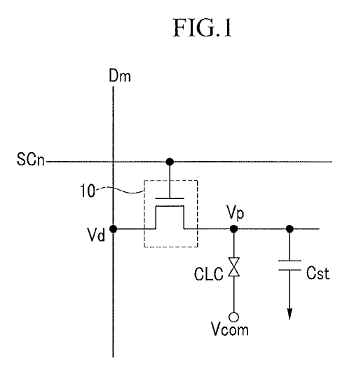

FIG. 1 is a circuit diagram of a pixel driving circuit according to an exemplary embodiment.

A liquid crystal display panel including a plurality of pixels according to an exemplary embodiment is included in the general liquid crystal display (LCD) and is displayed such that the description for detailed configurations of the general liquid crystal display (LCD) including a controller, a data driver, a gate driver, and a power supply unit is omitted.

As shown in FIG. 1, a plurality of pixels forming the liquid crystal display panel displaying the image according to the image data signal are disposed at predetermined regions where a corresponding data line Dm among a plurality of data lines and a corresponding scan line SCn among a plurality of scan lines are intersected and are connected to the corresponding data line Dm and the corresponding scan line SCn.

The plurality of data lines extend in a longitudinal direction and are connected to a data driver (not shown), and the plurality of scan lines extend in a transverse direction and are connected to a gate driver (not shown).

The corresponding scan line SCn among the plurality of scan lines is connected to a gate electrode of a thin film transistor 10 disposed in a pixel shown in FIG. 1, and the corresponding data line Dm among a plurality of data lines is connected to the first electrode of the thin film transistor 10.

The thin film transistor 10 is turned on by the scan signal applied through the corresponding scan line SCn, and a predetermined voltage is transmitted through the first electrode of the turned on thin film transistor 10 during one frame period. That is, a reset voltage is transmitted during a predetermined first period among one frame period, and the data voltage according to the data signal is transmitted during a predetermined second period among one frame period.

The second electrode facing the first electrode of the thin film transistor 10 is connected to a storage capacitor Cst and a liquid crystal layer CLC.

One terminal of the storage capacitor Cst is connected to the second electrode of the thin film transistor 10, and the other terminal thereof may be connected to a common electrode or an additional electrode that is separately provided.

One terminal of the liquid crystal layer CLC is a pixel electrode connected to the second electrode of the thin film transistor 10, and the other terminal thereof is connected to the common electrode thereby receiving a common voltage Vcom.

The common electrode may apply the common voltage Vcom to each liquid crystal layer CLC of a plurality of pixels included in the liquid crystal display panel through a common electrode line.

The liquid crystal layer CLC includes a liquid crystal between the upper substrate and the lower substrate, and according to an exemplary embodiment, a liquid crystal layer having a plurality of liquid crystal application voltages versus the light transmittance characteristic curve (V-T curve or voltage curve) having the hysteresis characteristics by the influence of the previous gray voltage is used.

Preferably, the liquid crystal layer CLC may be a polymer dispersed liquid crystal layer having the hysteresis characteristic.

The polymer dispersed liquid crystal layer is formed by a mixture of a liquid crystal, a reactive mesogen (RM), and a polymer compound, and may use one selected from a polymer dispersed liquid crystal (PDLC), a polymer network liquid crystal (PNLC), a polymer stabilized liquid crystal (PSLC), a liquid crystal stabilized polymer (LCSP), and a polymer stabilized ferroelectric liquid crystal (PSFLC).

The polymer dispersed liquid crystal layer CLC has the effects that light transmittance is excellent and the contrast ratio is improved. However, hysteresis may be generated, in which the expression of grayscales according to the current data signal is not correct and is not displayed with constant luminance by the influence of the previous grayscale.

To correct the expression of grayscales by reducing the influence of the hysteresis, a period for applying the reset voltage is set before the expression of grayscales among one frame period.

In FIG. 1, the first electrode of the thin film transistor 10 of the pixel is applied with the data voltage Vd according to the data signal when the scan signal of the gate on voltage level is transmitted to the thin film transistor 10 to be turned on, and the reset voltage is applied to reset the liquid crystal layer CLC before the data voltage Vd is applied among the corresponding frame period.

The reset voltage is transmitted to the pixel electrode of the liquid crystal layer through the first electrode and the second electrode of the thin film transistor 10 to reset the liquid crystal layer CLC.

The reset voltage is not limited, however, and it may preferably be a saturation voltage. As an exemplary embodiment, in a normally black mode, a white voltage level may be set as the reset voltage, and in a normally white mode, a black voltage level may be set as the reset voltage.

The reset voltage may be set as the level that is equal to or more than a voltage level of a maximum value among absolute values of the data voltage that is applied to the pixel.

The polymer dispersed liquid crystal that is arranged corresponding to the previous grayscale data voltage for the previous expression of grayscales is rearranged corresponding to the reset voltage before the grayscale data voltage for the current expression of grayscales is applied. Accordingly, when the current grayscale data voltage is applied and is displayed, the gray voltage of the previous frame may not be influenced.

If the reset voltage is transmitted, when the scan signal having the gate on voltage level is transmitted, the thin film transistor 10 is turned on such that the data voltage Vd is applied from the first electrode of the thin film transistor 10 and is transmitted to the pixel electrode of the liquid crystal layer CLC through the second electrode. In the manufacturing process of the liquid crystal display (LCD), the second electrode of the thin film transistor 10 is shorted to the pixel electrode of the liquid crystal. Accordingly, the voltage of the second electrode has the same value as the voltage Vp of the pixel electrode. Therefore, the transmitted data voltage Vd becomes the voltage Vp of the pixel electrode, the liquid crystal included in the liquid crystal layer CLC is aligned by the difference between the voltage Vp of pixel electrode and the common voltage Vcom applied to the common electrode, and a predetermined image is displayed by a light source that is emitted at the rear side of the liquid crystal.

According to an exemplary embodiment of, the liquid crystal included in the liquid crystal layer CLC is reset by the reset voltage before the data voltage Vd is applied to the pixel electrode such that the grayscale of the data voltage may be expressed by using one V-T curve among two V-T curves in which the hysteresis characteristic is generated.

The storage capacitor Cst that is commonly connected to the pixel electrode of the liquid crystal layer CLC has the function of maintaining the reset voltage or the grayscale data voltage during a predetermined period.

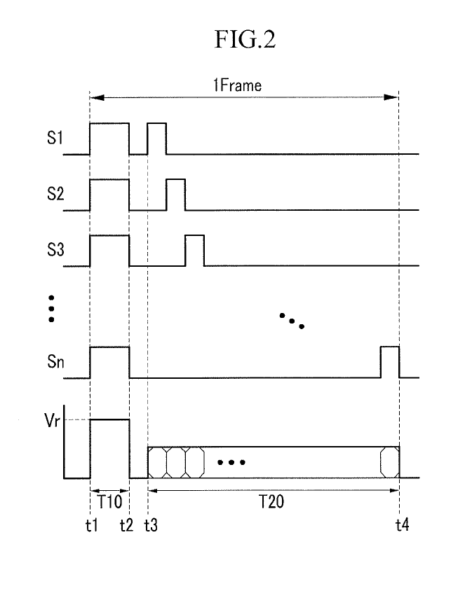

FIG. 2 is a timing diagram explaining an operation of the pixel driving circuit of FIG. 1 by an exemplary embodiment.

FIG. 2 shows a driving process for displaying an image according to a data signal through a scan signal that is transmitted to a plurality of pixels in a liquid crystal display (LCD) including a liquid crystal display panel including the plurality of pixels shown in FIG. 1 as a timing diagram.

As shown in FIG. 2, a driving method of a liquid crystal display (LCD) according includes two reset sections T10 and a data writing section T20 in one frame. One frame is divided into the reset section T10 for resetting the liquid crystal layer CLC that is displayed by the previous grayscale data voltage in the previous frame, and the data writing section T20 in which the data voltage according to the data signal is transmitted and is displayed as the grayscale in the current frame.

In the reset section T10 as the section from the time t1 to the time t2, a plurality of scan signals S1 to Sn are transmitted during the reset period T10 through a plurality of scan lines that are connected to the gate electrodes of the thin film transistors 10 of a plurality of pixels forming the liquid crystal display panel. A plurality of scan signals S1 to Sn are respectively transmitted to a plurality of scan lines that are disposed according to the pixel row of a plurality of pixels of the liquid crystal display panel. In the reset period, that scan signal that is transmitted to the gate electrode of the thin film transistor 10 respectively included in all pixels is transmitted as a predetermined gate on voltage level, and thereby the thin film transistor 10 is turned on during the reset section. Thus, a reset voltage Vr is transmitted through the corresponding data line connected to the first electrode of the thin film transistor 10 during the reset period T10.

According to an exemplary embodiment, the reset voltage Vr may be the saturation voltage that is equal to or more than the maximum value among the absolute value of the data voltage. According to another exemplary embodiment, the reset voltage Vr may be the white voltage level or the black voltage level.

If the reset voltage Vr is transmitted to a plurality of pixels such that it is transmitted to the pixel electrode of the liquid crystal layer CLC included in a plurality of pixels, the liquid crystal included in the liquid crystal layer CLC is rearranged corresponding to the reset voltage Vr. Thus, the liquid crystal arrangement characteristic according to the grayscale data voltage in the previous frame does not influence the grayscale data expression of the current frame.

In the data writing section T20 as the section from the time t3 to the time t4, a plurality of scan signals S1 to Sn that are transmitted to the plurality of scan lines connected to the plurality of pixel rows are sequentially transmitted as the gate on voltage level. The scan signal S1 that is transmitted to the first scan line is transmitted as the gate on voltage level to the plurality of pixels included in the first pixel row at the time t3, and then the scan signal S2 that is transmitted to the second scan line is transmitted as the gate on voltage level to the plurality of pixels included in the second pixel row.

By this method, the n-th scan signal Sn is transmitted as the gate on voltage level to the scan line connected to the n-th pixel row as the last pixel row.

All pixels included in the liquid crystal display panel are sequentially scanned according to the pixel row, and the thin film transistors respectively included in a plurality of pixels included in the pixel row are sequentially turned on.

The data voltage is transmitted from the corresponding data line Dm through the first electrode of the thin film transistor 10 that is sequentially turned on according to the pixel row. The data voltage levels transmitted to a plurality of pixels during the current frame are different from one another, the corresponding data voltage is transmitted as the voltage of the pixel electrode of the liquid crystal layer CLC, and the liquid crystal of the liquid crystal layer CLC are arranged by the difference between the voltage of the pixel electrode and the voltage of the common electrode. Thus, the grayscale according to the corresponding data voltage is expressed.

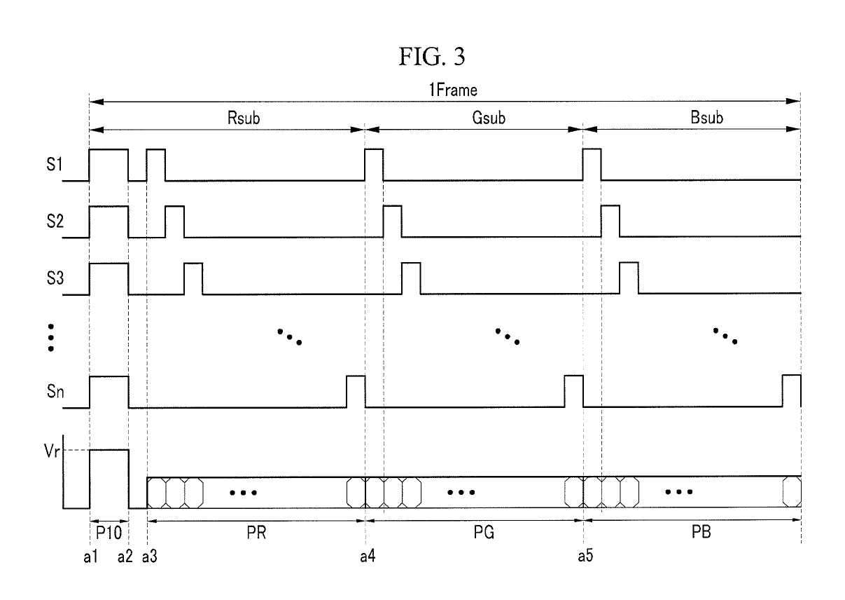

FIG. 3 is a timing diagram explaining an operation of the pixel driving circuit of FIG. 1 by another exemplary embodiment of the present invention different from FIG. 2. In the driving method of the liquid crystal display according to the exemplary embodiment of FIG. 3, one frame may include a plurality of subframes Rsub, Gsub, and Bsub.

Referring to 3, the R sub-frame Rsub of the plurality of sub-frames includes a reset section P10 and a data writing section PR.

That is, the R sub-frame Rsub includes the reset section P10 applying a reset voltage to reset the liquid crystal layer CLC that is displayed by the corresponding grayscale data voltage in the previous frame or in the previous sub-frame.

In the exemplary embodiment of FIG. 3, the reset section is positioned in the initial sub-frame period among the plurality of sub-frames, this is one exemplary embodiment, and a predetermined reset section may be initially set up in each sub-frame period.

During the reset section P10 from the time a1 to the time a2, a plurality of scan signals S1 to Sn are transmitted through a plurality of scan lines that are connected to the gate electrodes of the thin film transistors 10 of a plurality of pixels forming the liquid crystal display panel. Thus, the thin film transistors 10 of the plurality of pixels are turned on during the reset section and the reset voltage is transmitted through the data line.

After the passage of the reset section P10 of the R sub-frame Rsub, a plurality of scan signals 51 to Sn are sequentially transmitted to the thin film transistors 10 of a plurality of pixels forming the liquid crystal display panel from the time a3 to the time a4.

Thus, the thin film transistors 10 of a plurality of pixels included in the pixel row are sequentially turned on and the data voltage corresponding to the R sub-frame Rsub is transmitted from the data line through the first electrode of the thin film transistors 10 that are sequentially turned on.

Next, a plurality of scan signals S1 to Sn are sequentially transmitted to the thin film transistors 10 of the plurality of pixels from the time a4 to the time a5 such that the data voltage corresponding to the G sub-frame Gsub is transmitted in the data writing period PG of the G sub-frame Gsub.

Next, a plurality of scan signals S1 to Sn are again sequentially transmitted from the time a5, and the data voltage corresponding to the B sub-frame Bsub is written in the data writing period PB of the B sub-frame Bsub with the same method.

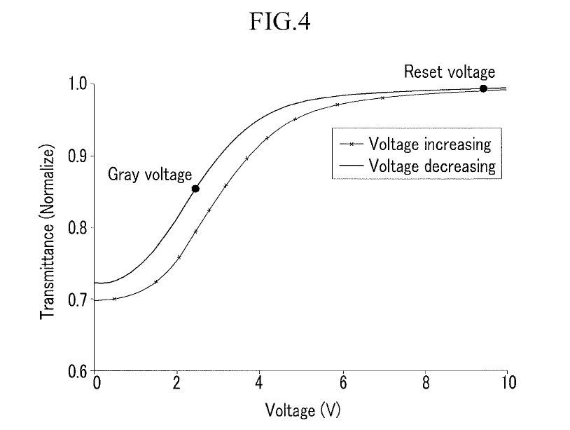

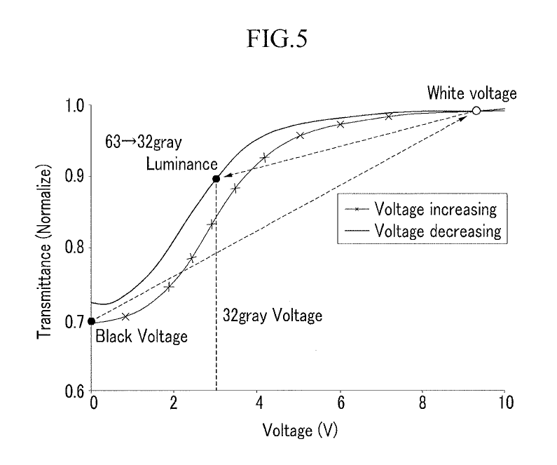

FIG. 4 and FIG. 5 are V-T curve graphs to explain a driving method of a liquid crystal display (LCD) according to an exemplary embodiment.

The liquid crystal display (LCD) according to an exemplary embodiment includes the liquid crystal layer CLC having the hysteresis characteristic such that the V-T curves that are applied to the case that the gray voltage is increased and decreased compared with the previous gray voltage when expressing the gray voltage are different from one another, as shown in FIG. 4.

In the case that the voltage is increased, the liquid crystal is arranged corresponding to the lower voltage curve among the V-T curves of FIG. 4 to have the light transmittance for the corresponding voltage such that the luminance according to the corresponding light transmittance is realized.

In contrast, in the case that the voltage is decreased, the liquid crystal is arranged corresponding to the upper voltage curve among the V-T curves of FIG. 4 to have the light transmittance for the corresponding voltage such that the luminance according thereto is displayed.

Accordingly, the grayscale for the different voltage curves is expressed according to whether the grayscale data voltage of the current frame is increased or decreased compared with the grayscale data voltage of the previous frame such that the transmittance is different by the hysteresis of the liquid crystal layer although the same voltage is applied. Thus, the luminance is different.

As shown in FIG. 4, the driving method according to an exemplary embodiment inserts the reset section for applying the reset voltage in the beginning of the frame, i.e., before the data voltage is transmitted in each frame, such that the liquid crystal of the liquid crystal layer is rearranged into the alignment corresponding to the reset voltage.

When the grayscale data voltage is applied in the current frame in applying the light transmittance according to the corresponding grayscale data voltage, one voltage curve may be applied among two V-T curves having the hysteresis characteristic. Preferably, as shown in FIG. 4, the reset voltage may be set as the white voltage level as the saturation voltage. Thus, the V-T curve of the voltage decreasing corresponding to the direction that the liquid crystal applying voltage is decreased from the maximum value to the minimum value is selected, and thereby the luminance corresponding to the grayscale data voltage may be displayed.

The driving method of the liquid crystal display (LCD) according to present embodiments will be described in detail with reference to FIG. 5.

When expressing the gray 32 in the current frame after the gray 0 and gray 63 are respectively expressed in the previous frame, the liquid crystal display (LCD) including the liquid crystal layer having the hysteresis characteristic changes the grayscales according to the different V-T curves having the hysteresis characteristic. In the case the voltage is increased when the image is changed from the gray 0 to the gray 32, the V-T curve of the voltage increasing in the direction that the liquid crystal applying voltage is increased is applied, and the V-T curve of the voltage decreasing in the direction that the liquid crystal applying voltage is decreased is applied in the case that the image is changed from the gray 63 to the gray 32. Accordingly, in spite of the equal expression of the gray 32, the liquid crystal layer of the liquid crystal display (LCD) is arranged to have the different light transmittance of about 0.85 and 0.9 by the influence of the grayscale data voltage of the previous frame. Accordingly, the luminance difference for the same grayscale data voltage is generated.

However, according to the driving method of the liquid crystal display (LCD), the liquid crystal is rearranged by the saturation voltage to be reset regardless of whether the grayscale expressed in the previous frame is the gray 0 or gray 63. In FIG. 5, the reset voltage is predetermined as the white voltage level, and thereby the voltage corresponding to the gray 0 that is displayed in the previous frame is increased to the voltage level of the reset voltage as the saturation voltage. To express the gray 32 in the current frame, the V-T curve of the voltage that is decreasing among two V-T curves is selected such that the luminance corresponding to the voltage curve is generated.

When the voltage corresponding to the gray 63 is displayed in the previous frame, the gray 32 corresponding to the V-T curve of the voltage that is decreasing among two V-T curves is displayed after the reset such that the gray 32 may be displayed with the same luminance in the current frame, regardless of the grayscale data voltage of the previous frame.

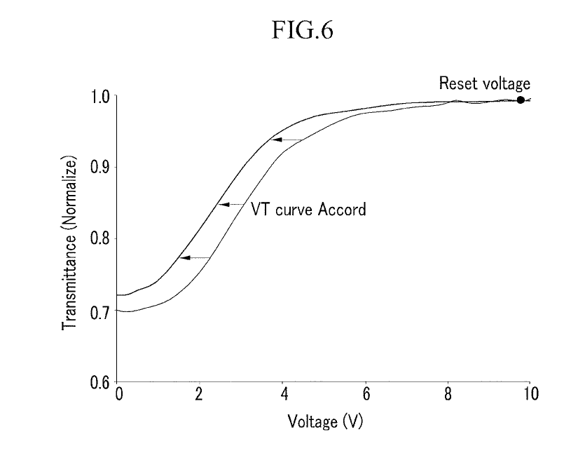

FIG. 6 is a graph of a V-T curve showing an expression of grayscales that are improved according to a driving method of a liquid crystal display (LCD) according to an exemplary embodiment. As shown in FIG. 6, the driving method of the liquid crystal display (LCD) including the liquid crystal layer having the hysteresis characteristic selects the V-T curve of the voltage that is decreasing in the direction that the liquid crystal applying voltage is decreased among a plurality of V-T curves having the hysteresis characteristic under the expression of grayscales to accord the V-T curve for the expression of grayscales such that the luminance according to the same data voltage may be constantly displayed. Also, the reset voltage is predetermined as the single voltage such that there is simple driving and easy application.

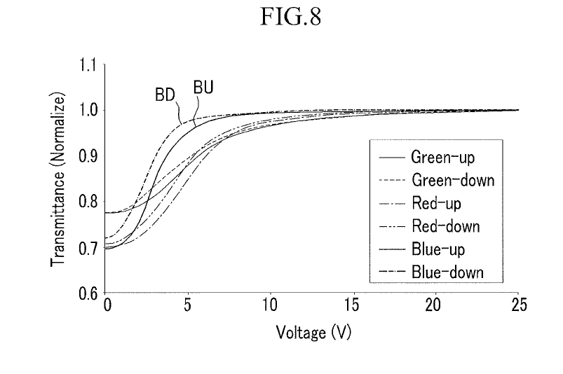

In the exemplary embodiment, the reset voltage is predetermined as the saturation voltage. However, it is not limited thereto, and a threshold voltage of the liquid crystal may be predetermined. A case in which the reset voltage is predetermined as the threshold voltage of the liquid crystal is a time when the black luminance is accorded like a plurality of voltage curves having the hysteresis characteristic displaying green of FIG. 8. At this time, the black voltage is predetermined as the reset voltage, and a curve of the voltage that is increasing in the direction that the liquid crystal applying voltage is increased among a plurality of voltage curves is selected when expressing the grayscale to express the grayscale.

By way of summation and review, the liquid crystal display (LCD) of the related art includes a liquid crystal panel including an upper substrate, a lower substrate, and a liquid crystal between the upper substrate and the lower substrate, a driving circuit driving the liquid crystal panel, and a backlight unit providing white light to the liquid crystal.

The liquid crystal used in the liquid crystal displays (LCDs) is a liquid crystal material of a twisted nematic (TN) type or a super twisted nematic (STN) type. The liquid crystal display (LCD) using this liquid crystal includes a polarizing plate such that light usage efficiency is low, thereby decreasing the contrast ratio. Also, the liquid crystal display (LCD) requires surface alignment. However, if pixel density is increased, alignment treatment near a thin film transistor is difficult and the viewing angle is about 20°. To solve this problem, applying a transmission and scattering mode to a display element without a polarizing plate has been tried. As the result of this effort, a polymer dispersed liquid crystal (PDLC) or a polymer network liquid crystal (PNLC) of a light scattering mode dispersing the liquid crystal has been proposed.

However, the polymer dispersed liquid crystal material in a light scattering mode has a hysteresis characteristic, thereby having an influence of the previous grayscale. Although the same voltage is applied, the luminance is not uniform because there is a difficulty in expression of grayscales.

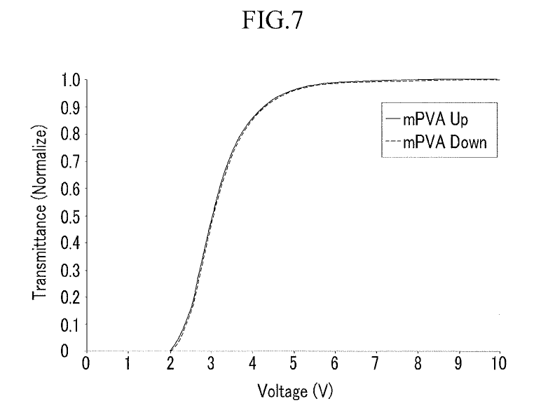

FIG. 7 is a graph of a V-T curve showing a liquid crystal application voltage versus a transmittance of a liquid crystal display (LCD) having a general liquid crystal element. The liquid crystal display (LCD) has the same V-T characteristic regardless of whether the applied data voltage is increased or decreased. Accordingly, it is possible to express the determined grayscale for the constant voltage by the V-T curve.

However, the V-T curve of a liquid crystal display (LCD) including a polymer dispersed liquid crystal developed to increase the contrast ratio by improving light usage efficiency of the liquid crystal display (LCD) has a hysteresis characteristic due to the hysteresis characteristic of the liquid crystal layer.

Referring to the graph of FIG. 8 showing a V-T curve for color of the liquid crystal display (LCD) including the liquid crystal layer with the hysteresis characteristic, in the case of expressing the same color like R, G, or B, two different V-T curves are shown according to the voltage change of the gray voltage of the previous frame and the gray voltage of the current frame such that the V-T curves have the hysteresis characteristic.

Although the same voltage is applied, the corresponding voltage curves are different according to the previous gray voltage that is larger or smaller than the voltage that is currently applied. Accordingly, although the same voltage is applied according to the previous grayscale, the luminance is changed such that gamma tuning is impossible and the luminescence characteristics may be deteriorated.

In the graph of FIG. 8, in the case of an example of a voltage curve expressing blue BU and BD, when the gray voltage applied to the current frame is larger than the gray voltage applied to the previous frame, the voltage change is increased. Thus, the grayscale corresponding to the lower V-T(BU) curve among two V-T curves (BU and BD) is expressed.

Also, when the gray voltage applied to the current frame is smaller than the gray voltage applied to the previous frame voltage, the voltage change is decreased such that the grayscale corresponding to the upper V-T(BD) curve among two V-T curves (BU and BD) is expressed.

Although the same voltage is expressed in the current frame, the difference of the liquid crystal transmittance is generated according to the previous gray voltage by at least 2 different V-T curves having the hysteresis characteristic such that the luminances are different from each other.

When the previous grayscale of 20 is changed into the current gray 32, and the previous grayscale of 40 is changed into the current gray of 32, the current gray voltages are the same, however a different V-T curve is applied by the hysteresis characteristic of the plurality of V-T curves such that the liquid crystal display does not have the same transmittance. Thus, the luminance is changed.

Accordingly, an improved driving method of a liquid crystal display (LCD) according to exemplary embodiments expresses the same luminance regardless of the previous grayscale when expressing the grayscale through the application of the same voltages in the liquid crystal display (LCD) using the liquid crystal layer having the hysteresis characteristic.

Accordingly, the disclosed embodiments provide an improvement of the driving method capable of expressing a grayscale data voltage for constant luminance according to the data signal over the liquid crystal display (LCD) using the liquid crystal material having the hysteresis characteristic.

Embodiments are directed to a liquid crystal display that is displayed with a constant luminance under the same voltage application without an influence of a pervious grayscale in a liquid crystal display (LCD) including a liquid crystal layer having a hysteresis characteristic, and a driving method thereof.

Embodiments are directed to a method of displaying with a gray voltage by using one voltage curve in a liquid crystal display (LCD) having hysteresis of at least two liquid crystal application voltages versus a transmittance characteristic curve (hereinafter, referred to as “voltage curve” or “V-T curve”) in a previous grayscale display due to a liquid crystal layer having a hysteresis characteristic.

According to present embodiments, for the expression of grayscales of the liquid crystal display (LCD) including the liquid crystal layer having the hysteresis characteristic, constant luminance may realize expression of grayscales under the application of the same data voltage without influence of the previous grayscale by the hysteresis of the liquid crystal.

Also, the luminance change for the same gray voltage according to a plurality of V-T curves having the hysteresis characteristic by the liquid crystal layer having the hysteresis characteristic may be improved, and the single V-T curve is selected and used to display the grayscale such that the liquid crystal display (LCD) having the correct luminance and the high quality may be provided.

While these embodiments have been described in connection with what is presently considered to be practical exemplary embodiments, it is to be understood that embodiments are not limited to the disclosed embodiments. On the contrary, the embodiments are intended to cover various modifications and equivalent arrangements included within the spirit and scope of the appended claims. Further, the materials of the components described in the specification may be selectively substituted by various known materials by those skilled in the art. In addition, some of the components described in the specification may be omitted without deterioration of performance or added in order to improve the performance by those skilled in the art. Moreover, the sequence of the steps of the method described in the specification may be changed depending on a process environment or equipment by those skilled in the art. Accordingly, the scope of the embodiments should be determined not by the above-mentioned exemplary embodiments, but by the appended claims and equivalents thereto.

Example embodiments have been disclosed herein, and although specific terms are employed, they are used and are to be interpreted in a generic and descriptive sense only and not for purpose of limitation.

What is claimed is:

1. A driving method of a liquid crystal display (LCD) including a liquid crystal layer having a hysteresis characteristic according to a plurality of voltage curves for a liquid crystal applying voltage versus transmittance, the method comprising:
applying a reset voltage to the liquid crystal layer before a plurality of gray voltages according to grayscale data of one frame;
generating the gray voltages corresponding to one voltage curve selected according to the reset voltage among the plurality of voltage curves according to the hysteresis characteristic; and
applying the gray voltages to a corresponding region of the liquid crystal layer.

2. The method as claimed in claim 1, wherein
the reset voltage is a saturation voltage or a threshold voltage.

3. The method as claimed in claim 2, wherein
the one voltage curve selected according to the reset voltage is a voltage curve according to a direction that the liquid crystal applying voltage is decreased from a maximum value to a minimum value among the plurality of voltage curves when the reset voltage is the saturation voltage, and
the one voltage curve selected according to the reset voltage is a voltage curve according to a direction that the liquid crystal applying voltage is increased from a minimum value to a maximum value among the plurality of voltage curves when the reset voltage is the threshold voltage.

4. The method as claimed in claim 3, wherein
in a case of a normally black mode, the saturation voltage is a white voltage.

5. The method as claimed in claim 3, wherein
in a case of a normally white mode, the saturation voltage is a black voltage.

6. The method as claimed in claim 1, wherein
the liquid crystal layer is a polymer dispersed liquid crystal layer in which a liquid crystal, a reactive mesogen (RM), and a polymer compound are mixed.

7. The method as claimed in claim 6, wherein
the polymer dispersed liquid crystal layer includes one selected from a polymer dispersed liquid crystal (PDLC), a polymer network liquid crystal (PNLC), a polymer stabilized liquid crystal (PSLC), a liquid crystal stabilized polymer (LCSP), and a polymer stabilized ferroelectric liquid crystal (PSFLC).

8. A driving method of a liquid crystal display (LCD) including a liquid crystal layer having a hysteresis characteristic according to a plurality of voltage curves for a liquid crystal applying voltage versus transmittance and displaying a predetermined color by sequentially driving the liquid crystal layer during one frame period that is divided into a plurality of sub-frames, the method comprising:
applying a reset voltage to the liquid crystal layer before a plurality of gray voltages according to grayscale data of every sub-frame of the plurality of sub-frames;
generating the gray voltages corresponding to one voltage curve selected according to the reset voltage among the plurality of voltage curves according to the hysteresis characteristic; and
applying the gray voltages to a corresponding region of the liquid crystal layer.

9. The method as claimed in claim 8, wherein
the one voltage curve is a voltage curve according to a direction that the liquid crystal applying voltage is decreased from a maximum value to a minimum value among the plurality of voltage curves.

10. The method as claimed in claim 8, wherein
the reset voltage is a saturation voltage or a threshold voltage.

11. The method as claimed in claim 10, wherein
in a case of a normally black mode, the saturation voltage is a white voltage.

12. The method as claimed in claim 10, wherein
in a case of a normally white mode, the saturation voltage is a black voltage.

13. The method as claimed in claim 8, wherein
the plurality of sub-frames include Red (R), Green (G), and Blue (B) sub-frames.

14. The method as claimed in claim 8, wherein
the plurality of sub-frames respectively include a first section in which the reset voltage is applied to the liquid crystal layer and a second section in which the gray voltages corresponding to one voltage curve selected among the plurality of voltage curves are applied to the corresponding region of the liquid crystal layer.

15. The method as claimed in claim 8, wherein
the polymer dispersed liquid crystal layer includes one selected from a polymer dispersed liquid crystal (PDLC), a polymer network liquid crystal (PNLC), a polymer stabilized liquid crystal (PSLC), a liquid crystal stabilized polymer (LCSP), and a polymer stabilized ferroelectric liquid crystal (PSFLC).

16. A liquid crystal display (LCD), comprising:
a plurality of pixels including a liquid crystal layer having a hysteresis characteristic of a plurality of voltage curves of a liquid crystal applying voltage versus transmittance and displaying an image;
a plurality of scan lines simultaneously transmitting a scan signal of a gate on voltage level to the plurality of pixels during a predetermined first period of one frame period and sequentially transmitting the scan signal of the gate on voltage level to the plurality of pixels during a predetermined second period of one frame period;
a plurality of data lines transmitting a reset voltage to the plurality of pixels during the predetermined first period and transmitting a plurality of gray voltages generated corresponding to one voltage curve selected according to the reset voltage among the plurality of voltage curves according to the hysteresis characteristic during the predetermined second period; and
a plurality of common electrode lines supplying a common voltage to the plurality of pixels,
wherein the plurality of pixels display a grayscale by applying the gray voltages transmitted during the predetermined second period to a corresponding region of the liquid crystal layer.

17. The liquid crystal display (LCD) as claimed in claim 16, wherein
the one voltage curve is a voltage curve according to a direction that the liquid crystal applying voltage is decreased from a maximum value to a minimum value among the plurality of voltage curves.

18. The liquid crystal display (LCD) as claimed in claim 16, wherein
the reset voltage is a saturation voltage or a threshold voltage.

19. The liquid crystal display (LCD) as claimed in claim 18, wherein
in a case of a normally black mode, the saturation voltage is a white voltage.

20. The liquid crystal display (LCD) as claimed in claim 18, wherein
in a case of a normally white mode, the saturation voltage is a black voltage.

21. The liquid crystal display (LCD) as claimed in claim 16, wherein
the polymer dispersed liquid crystal layer includes one selected from a polymer dispersed liquid crystal (PDLC), a polymer network liquid crystal (PNLC), a polymer stabilized liquid crystal (PSLC), a liquid crystal stabilized polymer (LCSP), and a polymer stabilized ferroelectric liquid crystal (PSFLC).

22. The liquid crystal display (LCD) as claimed in claim 16, wherein
the plurality of pixels respectively include:
a thin film transistor including a gate electrode connected to a corresponding scan line of the plurality of scan lines, a first electrode connected to a corresponding data line of the plurality of data lines, and a second electrode connected to a pixel electrode and turned on according to the scan signal transmitted through the corresponding scan line of the plurality of scan lines to receive the reset voltage and the plurality of gray voltages through the data line;
a storage capacitor connected to the second electrode of the thin film transistor and maintaining a pixel voltage applied to the pixel electrode; and
a liquid crystal layer interposed between the pixel electrode connected to the second electrode of the thin film transistor and the common electrode.
